(19) United States
(12) Patent Application Publication
(10) Pub. No.: US 2025/0139346 A1
(43) Pub. Date: May 1, 2025

(54) INTEGRATED CIRCUIT LAYOUT SHAPES

(71) Applicant: Taiwan Semiconductor Manufacturing Company, Ltd., Hsinchu (TW)

(72) Inventors: Chih-Wei CHANG, Taipei City (TW); Chun-Hua CHANG, Zhubei City (TW); Chun-Hsien WEN, Taoyuan County (TW); Johnny Chiahao LI, Taipei City (TW); Jerry Chang Jui KAO, Hsinchu (TW)

(21) Appl. No.: 18/496,509

(22) Filed: Oct. 27, 2023

(51) Int. Cl. G06F 30/392; G06F 113/10

(52) U.S. Cl. CPC G06F 30/392; G06F 2113/10

(57) ABSTRACT

A method for creating a layout element includes receiving an integrated circuit (IC) layout pattern that includes a shape corresponding to a component of the layout pattern. A mathematical definition of the shape is retrieved from a shape database, and parameter inputs regarding characteristics of the shape are received. A vertex listing is created based on the mathematical definition of the shape and the parameter inputs, and a layout element is created based on the vertex listing.

### BACKGROUND

Typically, automated tools are employed to assist semiconductor designers in manufacturing a circuit, including taking a functional design of a circuit to a finished layout of the circuit. Integrated circuit (IC) automated design tools are used to transform the circuit design into a circuit layout to be manufactured. This process includes turning a behavioral description of the circuit into a functional description, which is then decomposed into logic functions and mapped into rows of cells using a standard cell library that includes standard cells for predetermined logical functions, such as NAND, NOR, latch, and flip-flop functions. The standard cells may include a transistors, diodes, resistors, inductors, capacitors, or other suitable device, or a combination of one or more such devices formed in a substrate to perform the predetermined logical functions. Automatic place and route (APR) methods and systems may be employed to construct the IC layouts where selected standard cells are placed next to one another in the IC layout. Once mapped into rows of cells, a synthesis is performed to turn the structural design into a physical layout, a clock tree is built to synchronize the structural elements, and the design is optimized post layout. Certain portions of the design and manufacturing process tend to be manual, such as defining shapes of various layout elements.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1 is a block diagram schematically illustrating an example of a processing system, in accordance with some embodiments.

FIG. 2 is a diagram schematically illustrating an example IC design and fabrication process that may include the processing system of FIG. 1, in accordance with some embodiments.

FIG. 3 is a flow diagram illustrating an example shape generation method in accordance with some embodiments.

FIG. 4 is a block diagram illustrating an example of a memory storage of the processing system of FIG. 1, in accordance with some embodiments.

FIG. 5 is a flow diagram illustrating an example of an iterative layout pattern generation process in accordance with some embodiments.

FIG. 6 is a block diagram conceptually illustrating examples of via shapes in accordance with some embodiments.

FIG. 7 illustrates aspects of a 2D circularly-enclosed polygonal shape in accordance with some embodiments.

FIG. 8 illustrates an example of an inscribed square shape in accordance with some embodiments.

FIG. 9 illustrates an example of an inscribed pentagon shape in accordance with some embodiments.

FIG. 10 illustrates an example of an inscribed s heptagon shape in accordance with some embodiments.

FIG. 11 illustrates an example of a 2D rounded square shape in accordance with some embodiments.

FIG. 12 illustrates an example of a spiral shape in accordance with some embodiments.

FIG. 13 is a sectional side view illustrating aspects of a multilayer metal-insulator-metal (MIM) capacitor structure in accordance with some embodiments.

FIG. 14 illustrates top views of portions of the MIM capacitor of FIG. 13 in accordance with some embodiments.

FIG. 15 illustrates perspective views of examples of various 3D shapes in accordance with some embodiments.

FIG. 16 illustrates further aspects of some shapes illustrated in FIG. 15 in accordance with some embodiments.

FIG. 17 illustrates further aspects of other shapes illustrated in FIG. 15 in accordance with some embodiments.

FIG. 18A is a perspective view illustrating an example 3D shape in accordance with some embodiments.

FIG. 18B is a graph illustrating change in radius for the 3D shape shown in FIG. 18A.

FIG. 19A is a perspective view illustrating another example 3D shape in accordance with some embodiments.

FIG. 19B is a graph illustrating change in radius for the 3D shape shown in FIG. 19A.

FIG. 20A is a perspective view illustrating a further example 3D shape in accordance with some embodiments.

FIG. 20B is a graph illustrating change in radius for the 3D shape shown in FIG. 20A.

FIG. 21 illustrates perspective views of example 3D shapes formed by combining two 3D shapes in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower.” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Electronic design automation (EDA) tools are often used to assist semiconductor designers in manufacturing a circuit, including taking a functional design of a circuit to a finished layout of the circuit. The IC design typically includes standard cells or “intellectual property” (IP) blocks (used interchangeably herein), which refer to reusable, custom designed logic components, storage components, and the like. In integrated circuit (IC) manufacturing processes, many aspects of the design and manufacturing processes are automated. However, some portions of the process remain manual, such as creating various circuit layout elements of the standard cells. For instance, definitions and descriptions of various component and connector shapes are often created manually by drawing each individual shape. Such layout elements may be input by a user and saved as graphical data system (GDS) files, library exchange format (LEF) files, and the like, which tends to result in large file sizes for such graphical layout elements.

Redrawing efforts are required when aspects of the standard cells change, such as with design rule manual (DRM) updates, revised shape scaling, or shape updates, etc. In addition to the redrawing effort itself, the revised drawn shapes require quality checks (QC) each time they are revised. Moreover, layout element set expansions such as re-sized shapes or new shapes are difficult and time consuming. Additionally, when the created shapes are applied (i.e. “snapped”) to different manufacturing grids, shape distortion may occur, which in turn can requires additional QC checks.

With other prior standard cell shape definitions, predefined vertex lists are used to define the shape geometries. The vertex lists are converted to the corresponding shapes when used for circuit designs. This simplifies the process somewhat. For example, DRM updates require only update of the vertex lists as opposed to completely redefining and/or recreating shapes altogether. Each element/shape is required to have its vertex list defined at least once (e.g. initially).

However, each element with a distinct new shape requires a new, independent vertex definition file, and libraries of different shape defining vertex lists must be maintained. Still further, snapping to different manufacturing grids can still cause shape distortion, which in turn requires extra QC.

Aspects of this disclosure relate to alternative methods for describing and defining IC layout shapes. For instance, EDA tools and systems may be configured for defining and creating aspects of electronic architectural designs for an electronic device. The one or more electronic architectural designs can represent one or more images and/or one or more data-based representations of geometric shapes describing circuitry of the electronic device, locations of the geometric shapes, and/or interconnections between the geometric shapes.

In some examples, mathematical equations and software code are used to perform shape vertex list generation, rather than relying on manually drawn shapes or pre-defined vertex lists. Thus, shape defining parameters are required only for the design of the element. This simplifies the process of varying shape defining parameters. With some implementations, shapes are created automatically and can be generated in parallel given sets of parameters. Creating elements with new shapes and/or sizes requires only changing the parameters in the shape-generating equations. Moreover, since only the shape defining equations need be stored, file sizes are reduced. Snapping/calibrating to manufacturing grids is generally required only once without issues with shape distortion. Still further, shape profiles may be defined in three dimensions.

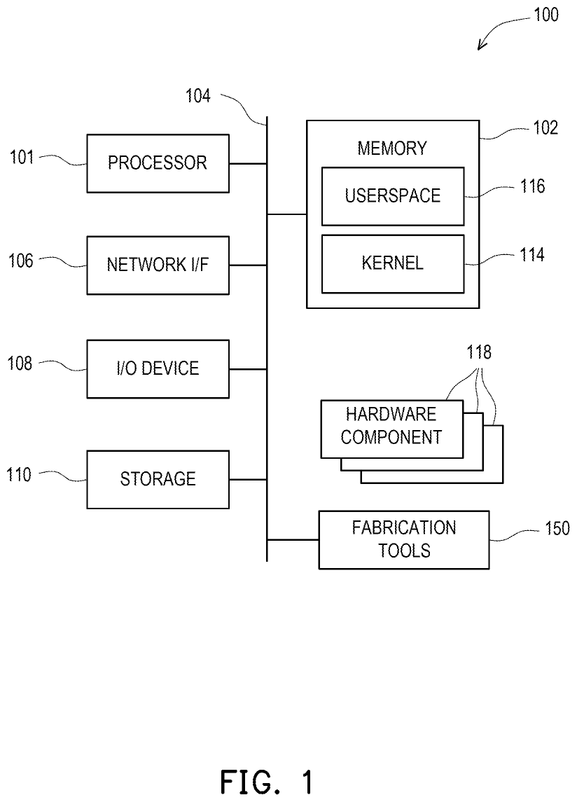

FIG. 1 is a block diagram schematically illustrating an example of a computer system 100, which may implement or be a component of an EDA system. In some embodiments, one or more operations and/or functionality of the tools and/or systems described herein are realized by the processor 101, which is programmed for performing such operations and/or functionality. One or more of the memory 102, the I/F 106, the storage 110, the I/O device 108, the hardware components 118, and the bus 104 are operable to receive instructions, data, design rules, netlists, layouts, models and/or other parameters for processing by the processor 101.

In some embodiments, one or more of the operations and/or functionality of the tools and/or systems described herein are implemented by specifically configured hardware (e.g., by one or more application specific integrated circuits or ASIC(s)) which are included) separate from or in lieu of the processor 101. Some embodiments incorporate more than one of the described operations and/or functionality in a single ASIC.

In some embodiments, the operations and/or functionality are realized as functions of a program stored in a non-transitory computer readable recording medium such as the storage 110 and/or memory 102. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, or other suitable non-transitory computer readable recording medium.

The computer system 100 may further include fabrication tools 150 for implementing the processes and/or methods stored in the storage 110, such as fabricating an IC. For instance, a synthesis may be performed on a design in which the behavior and/or functions desired from the design are transformed to a functionally equivalent logic gate-level circuit description by matching the design to standard cells selected from a layout unit library. The synthesis results in a functionally equivalent logic gate-level circuit description, such as a gate-level netlist. Based on the gate-level netlist, a photolithographic mask may be generated that is used to fabricate the integrated circuit by the fabrication tools 150.

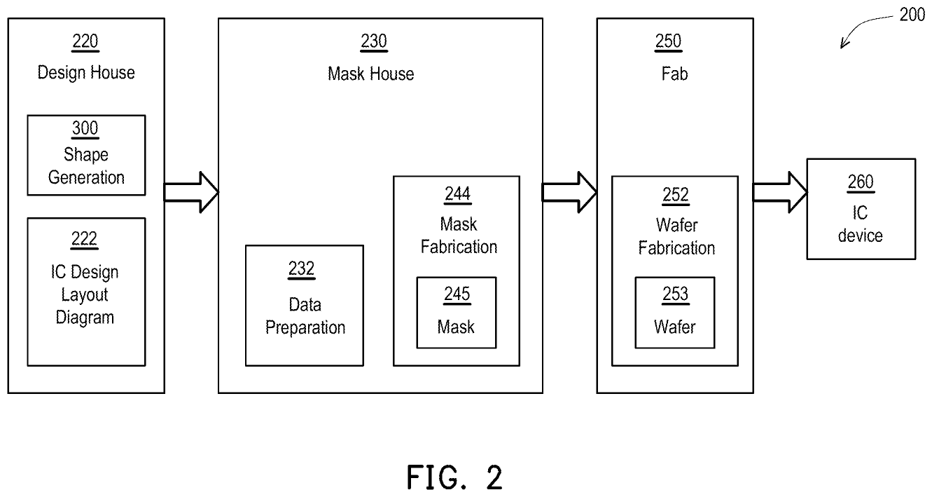

Further aspects of device fabrication are disclosed in conjunction with FIG. 2, which is a block diagram of IC manufacturing system 200, and an IC manufacturing flow associated therewith, in accordance with some embodiments. In some embodiments, based on a layout diagram, at least one of (A) one or more semiconductor masks or (B) at least one component in a layer of a semiconductor integrated circuit is fabricated using the manufacturing system 200.

In FIG. 2, the IC manufacturing system 200 includes entities, such as a design house 220, a mask house 230, and an IC manufacturer/fabricator (“fab”) 250, that interact with one another in the design, development, and manufacturing cycles and/or services related to manufacturing an IC device 260. The entities in the system 200 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of the design house 220, mask house 230, and IC fab 250 is owned by a single larger company. In some embodiments, two or more of design house 220, mask house 230, and IC fab 250 coexist in a common facility and use common resources.

The design house (or design team) 220 generates an IC design layout diagram 222. The design house 220 further includes a shape generation system or engine 300 that is configured to generate various geometrical patterns and shapes that are included in the layout diagram 222. In some embodiments, the geometrical shapes correspond to patterns of metal, oxide, or semiconductor layers that make up the various components of IC device 260 to be fabricated. The various layers combine to form various IC features. For example, a portion of the IC design layout diagram 222 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. The design procedure includes one or more of logic design, physical design or place and route.

Shape generation parameters and/or the IC design layout diagram 222 may be presented in one or more data files having information of the geometrical patterns. For example, IC design layout diagram 222 can be expressed in a GDS (i.e. GDSII) file format, LEF file format, DFII file format, and the like.

The mask house 230 includes a data preparation 232 and a mask fabrication 244. The mask house 230 uses the IC design layout diagram 222 to manufacture one or more masks 245 to be used for fabricating the various layers of the IC device 260 according to the IC design layout diagram 222. The mask house 230 performs mask data preparation 232, where the IC design layout diagram 222 is translated into a representative data file (“RDF”). The mask data preparation 232 provides the RDF to the mask fabrication 244. The mask fabrication 244 includes a mask writer. A mask writer converts the RDF to an image on a substrate, such as a mask (reticle) 245 or a semiconductor wafer 253. The design layout diagram 222 is manipulated by the mask data preparation 232 to comply with particular characteristics of the mask writer and/or requirements of the IC fab 250. In FIG. 2, the mask data preparation 232 and the mask fabrication 244 are illustrated as separate elements. In some embodiments, the mask data preparation 232 and the mask fabrication 244 can be collectively referred to as a mask data preparation.

In some embodiments, the mask data preparation 232 includes an optical proximity correction (OPC) which uses lithography enhancement techniques to compensate for image errors, such as those that can arise from diffraction, interference, other process effects and the like. The OPC adjusts the IC design layout diagram 222. In some embodiments, the mask data preparation 232 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, the mask data preparation 232 includes a mask rule checker (MRC) that checks the IC design layout diagram 222 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 222 to compensate for limitations during the mask fabrication 244, which may undo part of the modifications performed by OPC in order to meet mask creation rules.

In some embodiments, the mask data preparation 232 includes lithography process checking (LPC) that simulates processing that will be implemented by the IC fab 250 to fabricate the IC device 260. LPC simulates this processing based on the IC design layout diagram 222 to create a simulated manufactured device, such as the IC device 260. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine the IC design layout diagram 222.

It should be understood that the above description of mask data preparation 232 has been simplified for the purposes of clarity. In some embodiments, data preparation 232 includes additional features such as a logic operation (LOP) to modify the IC design layout diagram 222 according to manufacturing rules. Additionally, the processes applied to the IC design layout diagram 222 during data preparation 232 may be executed in a variety of different orders.

After the mask data preparation 232 and during the mask fabrication 244, a mask 245 or a group of masks 245 are fabricated based on the modified IC design layout diagram 222. In some embodiments, the mask fabrication 244 includes performing one or more lithographic exposures based on the IC design layout diagram 222. In some embodiments, an electron-beam (e-beam) or a mechanism of multiple e-beams is used to form a pattern on a mask (photomask or reticle) 245 based on the modified IC design layout diagram 222. The mask 245 can be formed in various technologies. In some embodiments, the mask 245 is formed using binary technology. In some embodiments, a mask pattern includes opaque regions and transparent regions. A radiation beam, such as an ultraviolet (UV) beam, used to expose the image sensitive material layer (e.g., photoresist) which has been coated on a wafer, is blocked by the opaque region and transmits through the transparent regions. In one example, a binary mask version of the mask 245 includes a transparent substrate (e.g., fused quartz) and an opaque material (e.g., chromium) coated in the opaque regions of the binary mask. In another example, the mask 245 is formed using a phase shift technology. In a phase shift mask (PSM) version of the mask 245, various features in the pattern formed on the phase shift mask are configured to have proper phase difference to enhance the resolution and imaging quality. In various examples, the phase shift mask can be attenuated PSM or alternating PSM. The mask(s) generated by the mask fabrication 244 is used in a variety of processes. For example, such a mask(s) is used in an ion implantation process to form various doped regions in the semiconductor wafer 253, in an etching process to form various etching regions in the semiconductor wafer 253, and/or in other suitable processes.

The IC fab 250 includes wafer fabrication 252. The IC fab 250 is an IC fabrication business that includes one or more manufacturing facilities for the fabrication of a variety of different IC products. In some embodiments, the IC Fab 250 is a semiconductor foundry. For example, there may be a manufacturing facility for the front end fabrication of a plurality of IC products (FEOL fabrication), while a second manufacturing facility may provide the back end fabrication for the interconnection and packaging of the IC products (BEOL fabrication), and a third manufacturing facility may provide other services for the foundry business.

The IC fab 250 uses mask(s) 245 fabricated by the mask house 230 to fabricate the IC device 260. Thus, the IC fab 250 at least indirectly uses the IC design layout diagram 222 to fabricate the IC device 260. In some embodiments, the semiconductor wafer 253 is fabricated by the IC fab 250 using mask(s) 245 to form the IC device 260. In some embodiments, the IC fabrication includes performing one or more lithographic exposures based at least indirectly on the IC design layout diagram 222. The Semiconductor wafer 253 includes a silicon substrate or other proper substrate having material layers formed thereon. The semiconductor wafer 253 further includes one or more of various doped regions, dielectric features, multilevel interconnects, and the like (formed at subsequent manufacturing steps).

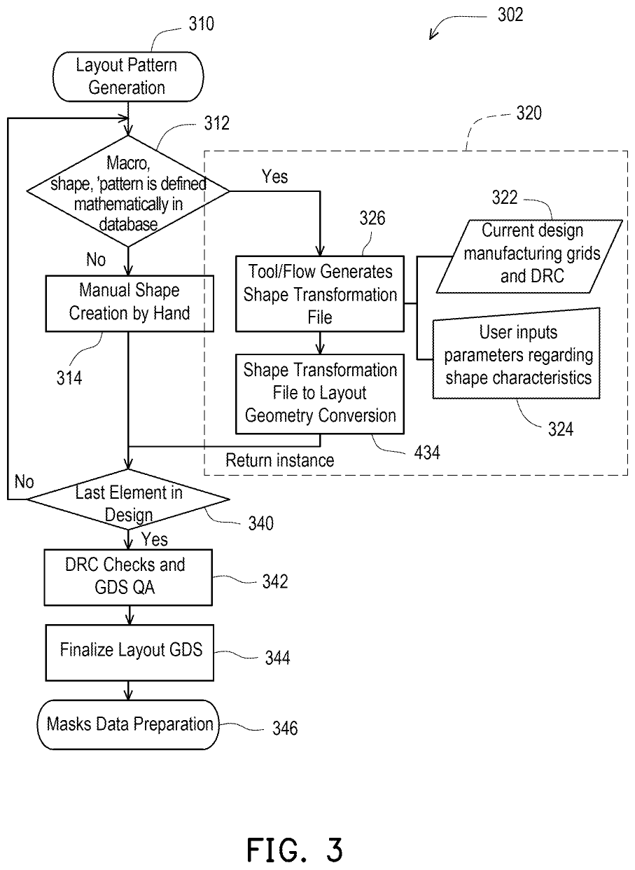

As noted above, disclosed embodiments further include a shape generation engine or system 300, which may be implemented by the EDA computer system 100 as part of the design house 220. FIG. 3 illustrates an example of a layout generation method 302, which may be implemented by a computer system such as the EDA system 100. The layout generation method 302 includes a layout pattern generation operation 310, which may include the IC design layout diagram 222 provided by the design house 220 shown in FIG. 2. As noted above, geometrical patterns and shapes are included in the layout diagram 222. In some embodiments, the layout pattern generation operation 310 includes geometrical shapes that correspond to patterns of metal, oxide, or semiconductor layers that make up the various components of an IC device to be fabricated. For example, the layout pattern generation operation 310 may specify shapes for various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate.

Rather than store image files or predefined vertex lists for the various shapes specified by the layout pattern generation operation 310, shape generation parameters are defined in mathematical expressions or equations that are stored in a database of the shape generation engine 300. Such a database may be saved, for example, in the storage 110 or memory 102 shown in FIG. 1. This database is accessible by the processor 101 to implement the disclosed methods. This greatly reduces the file sizes for storing shape information, saving space in memory devices 102, 110 and the like.

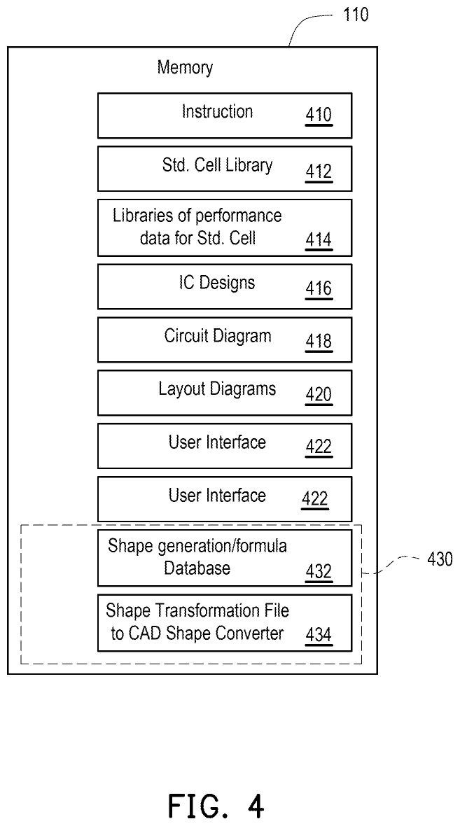

FIG. 4 illustrates an example of an EDA memory storage 110. The EDA memory 110 stores various files and information for the EDA system 100, such as program instructions 410, a standard cell library 412 that includes standard cells for predetermined logical functions and the like, performance data libraries 414 for associated standard cells, circuit diagrams 418, layout diagrams number 420, and one or more user interfaces 422.

Additionally, the EDA memory 110 shown in FIG. 4 includes mathematical shape definition information 430 used by the shape generation engine 300 and a shape generation process 320 shown in FIG. 3. More specifically, the shape definition information 430 in the example of FIG. 4 includes a shape generation/formula database 432 that stores mathematical definitions for various shapes used by the layout pattern generation operation 310. The mathematical shape definitions stored in the shape generation/formula database 432 may include, for example, parameters and mathematical formulas or equations defining various layout shapes. The shape definition information 430 may further include a shape converter process 434 configured for transforming shape vertex information generated by the shape generation process 320 to CAD files for use in the EDA system.

Returning to FIG. 3, at a decision block 312, it is determined if a mathematical definition for a particular shape specified by the layout pattern generation operation 310 is stored in the shape generation database 432. The mathematical definition may include, for example, parameters and mathematical formulas or equations defining various layout shapes.

Mathematical equations and software code stored in the shape generation database 432 are configured to generate shape vertex lists for the desired shapes. As such, only the mathematical definitions and shape defining parameters are used for the design of the shapes. This facilitates automatic shape generation (as opposed to manual shape generation and storage as image files, for example), which can be generated in parallel given sets of parameters. Thus, creating elements with new shapes and/or sizes only requires changing the parameters in the shape-generating equations. In some examples, only the shape defining equations need be stored in the shape generation/formula database 432, which reduces file size for shape storage.

Since the shapes are generated using mathematical definitions in this manner, it typically is only necessary to snap/calibrate the shapes to manufacturing grids once without future issues with shape distortion.

Referring again to FIG. 3, if the decision block 312 determines that the desired mathematical shape definition is stored in the shape generation/formula database 432, the method flows to the shape generation process 320. For example, the mathematical shape definition stored in the shape generation/formula database 432 along with design manufacturing grids and DRC information 322 and shape characteristic information 324 are input to automatically generate shape vertex information by a shape generation tool or process 326. The shape transformation converter 434 converts the shape information to a shape layout format such as a GDS file.

For example, in some embodiments the shape generation process 326 is configured to generate a vertex listing for a shape based on the retrieved mathematical description (e.g. mathematical formula) and input parameters. The vertex listing includes individual vertices that make up the shape. The vertices are typically defined as pairs of x and y coordinates (and z coordinates for 3D shapes) that mark the corners or significant points of the shape. For shapes defined by equations as discussed herein, a set of discrete points along the curve or equation may be generated to define the vertices. To generate the vertex listing, the list of coordinates is looped through to extract x and y components for each vertex.

In some examples, if the decision block 312 determines that there is no mathematical definition for the desired shape in the shape generation/formula database 432, the shape may be created manually at an operation 314. At a decision block 340 it is determined whether the created shape is the last element in the design. If there are additional design elements, the method returns to the decision block 312. If the last element in the design has been created as determined at the decision block 340, various design quality checks may be implemented at in operation 342, such as DRC checks and GDS quality checks. Following the quality checks 342, the layout GDS file is finalized at an operation 344, and mask data is prepared at operation 346. The GDS finalization 344 and masked data preparation 346 may be operations included in the data preparation function 232 of the mask house 230 shown in FIG. 2.

With known shape design processes, CAD shapes (e.g. graphic shape descriptions) can be sensitive to the manufacturing grid of a particular design. Even slight changes in the grid without rechecking the design could cause a shift in the lithography steps, resulting in mask shape distortions. Moreover, manufacturing grid changes, such as optical shrinking for advanced nodes, are common. The resulting shape rescaling and checking for proper snapping to the revised grid can labor intensive, especially for a large standard cell library. Disclosed shape generation processes using mathematical definitions of shapes can expedite such rescaling processes and ensure proper snapping, since the shape is simply re-instantiated using the revised manufacturing grid and DRC information 322 and/or user input parameters 324, thus reducing cycle time for mask creation.

In some embodiments, automated layout pattern generation for complex shapes is further enabled using shape characteristic parameters 324 input using artificial intelligence (AI) and machine learning (ML) tools to optimize shape creation.

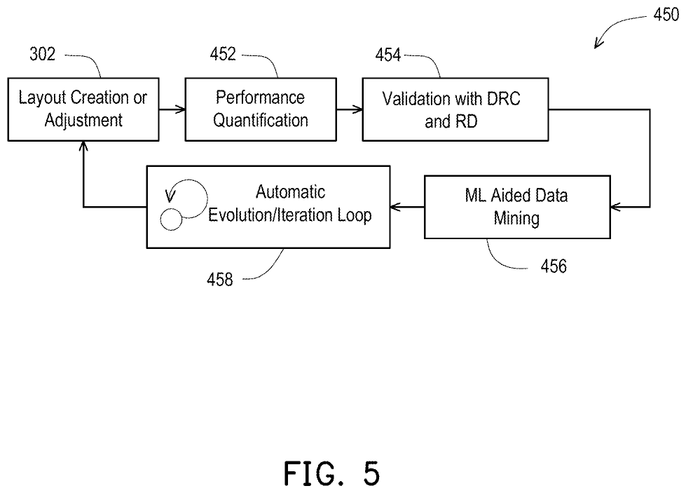

FIG. 5 illustrates such an example, where an iterative layout pattern generation process 450 includes a layout creation process such as the layout creation process 302 shown in FIG. 3. The generated layout is performance tested at operation 452 to quantify the layout performance, for example, through various simulations. Validation using criteria such as DRC checks is conducted at an operation 454, and data from the performance quantification 454 and validation 454 is input to a data mining operation 456, such as an ML aided data mining process. The generated data may then be used to vary input parameters, such as the shape parameters 324 input to the shape file generation process 326, by an evolution/iteration loop 458. The revised parameters and then input to the layout creation process 302, where the previous layout is adjusted and the process repeats to find the optimal shape definition.

In some examples, parametric equations are used to define x,y values for general parametric shapes. The received are used together with the equations to generate points for the shape definition. The parametric equations can be tailored to include different aspects, such as different basic shapes, skewness scaling, transformation factors, the shape's center xy location, etc. For example, shapes may be defined according to the following.

$$x = {S}_{x} ( x , y ) \cdot X ( y )$$

$$y = {S}_{y} ( x , y ) \cdot Y ( x )$$

Where Sₓ(x,y) and S_{y}(x, y) are shape transform functions and X(y) and Y(x) are the base shape defining parametric functions.

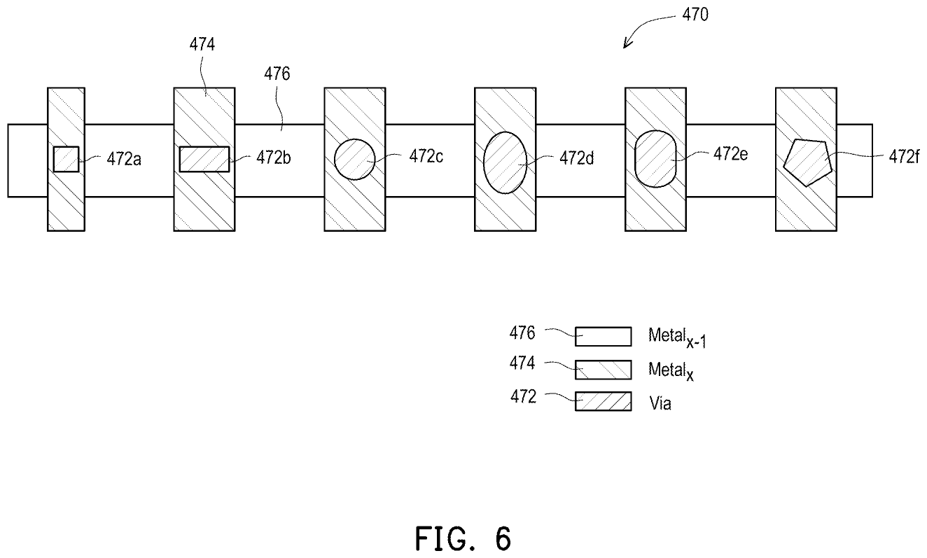

FIG. 6 illustrates a conductive connections structure 470 including various conductive vias 472 that conductively connect different metal layers. More specifically, the structure 470 illustrates several vias 472 having various two-dimensional (2D) shapes connecting two metal layers 474 and 476. In the example of FIG. 6, the first metal layer 474 is be designated as the metalₓ layer and the second metal layer 476 is designated the metalₓ₋₁ layer. In other words, the second metal layer 476 is directly below the first metal layer 474. For various IC layouts, the shape and scaling of conductive vias may vary depending on electrical requirements, types of metal used, dimensions of the conductors, etc. Instead of manually drawing different via shapes each time a different shape is required (with risks of incorrect dimensions, large image files, etc.), the illustrated embodiment uses mathematical definitions of shapes that are saved in the shape generation database 432 to generate the vias 472.

In the illustrated example, the vias 472 include a square-shaped via 472a and a rectangular via 472b (i.e. square shape scaled in the x direction). The square via 472a and the rectangular via 472b may be defined as follows.

$$\frac{{x}^{4}}{{s}_{x}} + \frac{{y}^{4}}{{s}_{y}} = {w}^{4}$$

Where Sₓ and S_{y} are shape transform functions and w is the width of the via.

The illustrated vias further include a circular via 472c and an oval shaped via 472d (circular shape scaled in the y direction), which may be defined as follows.

$$\frac{{x}^{2}}{{s}_{x}} + \frac{{y}^{2}}{{s}_{y}} = {r}^{2}$$

Where r is the radius.

A pill shaped via 472e may be defined as follows.

$$( x - a - \sqrt{{r}^{2} - {y}^{2}} ) ( x + a + \sqrt{{r}^{2} - {y}^{2}} ) ( y - r ) ( y + r ) = 1 {0}^{- 5}$$

Where a is the pill taper.

A pentagonal via 472f may be defined as follows.

$$\frac{cos ( \frac{π}{5} )}{cos ( θ - \frac{2 π}{5} \cdot floor ( \frac{5 θ + π}{2 π} ) )}$$

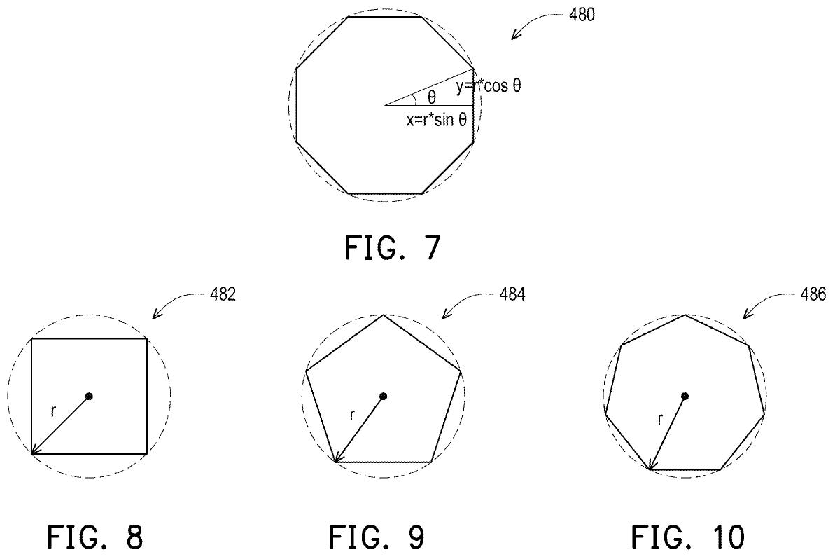

FIGS. 7-10 illustrate examples of shapes that include 2D circularly-enclosed polygonal elements. More particularly, FIGS. 7-10 illustrate examples of regular inscribed polygons 480, in which all of the vertices lie on a circle. Such shapes 480 may be automatically generated given the shape's center radius (r), and number of vertices desired(s). The shape is then defined by connecting vertices with straight lines. In the examples of FIGS. 7-10, vertices for the inscribed polygons may be defined as follows.

$$x = r \cdot sin ( θ \cdot ( 0. 5 + s ) )$$

$$y = r \cdot cos ( θ \cdot ( 0. 5 + s ) )$$

Where r is the center radius and s is the number of vertices, and I is the current side. FIGS. 8-10 illustrate specific shape examples for inscribed polygon shapes, including a square 482 (i.e. 4 vertices) in FIG. 8, a pentagon 484 (i.e. 5 vertices) in FIG. 9 and a heptagon 486 (i.e. 7 vertices) in FIG. 10.

In further embodiments, parametric equations or polynomials are used for arbitrary shape creation. For example, the following polynomial equation may be used to generate a desired shape geometry.

$${\sum }_{k = 0}^{n} {a}_{k} \cdot {x}^{2 k} \cdot {y}^{2 ( n - k )} = {r}^{2 n} \qquad {a}_{k} = {a}_{n - k}$$

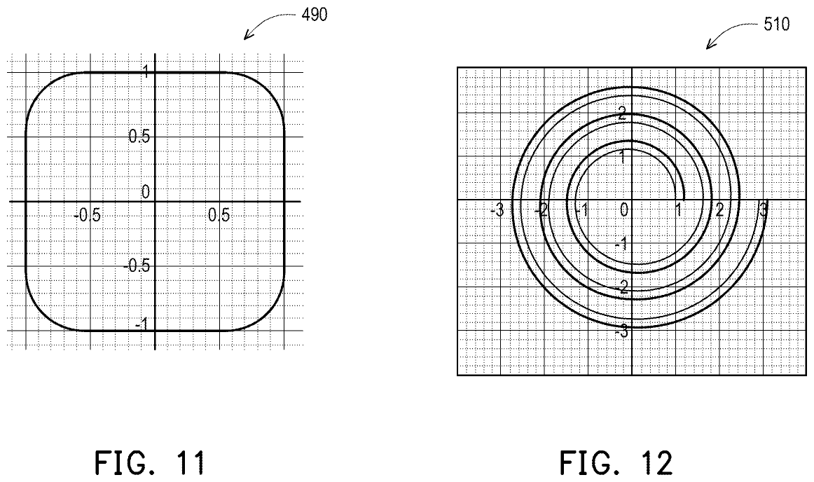

FIG. 11 shows a sample 2D rounded square shape 490. The equation above may be used to generate vertices for the rounded square shape 490, calculating coordinates of points on the perimeter of the rounded square shape 490. For n=4 (i.e., a square with 4 vertices), r=1, this equation simplifies to the following.

$${a}_{0} \cdot {x}^{2 ( 0 )} \cdot {y}^{2 ( 4 - 0 )} + {a}_{1} \cdot {x}^{2 ( 1 )} \cdot {y}^{2 ( 4 - 1 )} {a}_{2} \cdot {x}^{2 ( 2 )} \cdot {y}^{2 ( 4 - 2 )} + {a}_{3} \cdot {x}^{2 ( 3 )} \cdot {y}^{2 ( 4 - 3 )} + {a}_{4} \cdot {x}^{2 ( 4 )} \cdot {y}^{2 ( 4 - 4 )} = {r}^{2 \cdot 4}$$

aₖ represents a value associated with the vertex at index k and x and y are the coordinates of the points. The rounded square shape 490 is symmetric, so the coefficients of the vertices are symmetric (a_k=a_(n−k)). For the illustrated shape, the values of a₀-a₄ that satisfy the equation for each vertex are as follows.
a₀=1
a₁=0
a₂=1
a₃=0
a₄=1

These values may then be substituted into the equation for each vertex to find the corresponding x,y coordinates.

FIG. 12 illustrates an example of a spiral shape 510, which may be used in a layout to define a spiral inductor. The following is a mathematical equation for a basic Archimedean Spiral:

$$r = b + s θ$$

where r is the distance from the origin to a point on the spiral, s is the scale of the shape and b is the offset and θ is the angle of rotation. The following equations convert the spiral to x,y coordinates.

$$\begin{matrix}x = r \cdot cos θ = ( b + s θ ) \cdot cos θ \\ y = r \cdot sin θ = ( b + s θ ) \cdot sin θ\end{matrix}$$

To generate a pair of spiral shapes for a spiral inductor, a list of vertices can be generated by selecting a pair of spirals with desired offsets. In the example shown in FIG. 12, the offsets are b₁=0 (inner edge of the spiral) and b₂=0.1 (outer edge), and both spirals have the same scaling factor of s₁=s₂=0. The number of turns and relative positions of the turns (i.e. how close the turns are) can be adjusted based on the desired spiral inductor design.

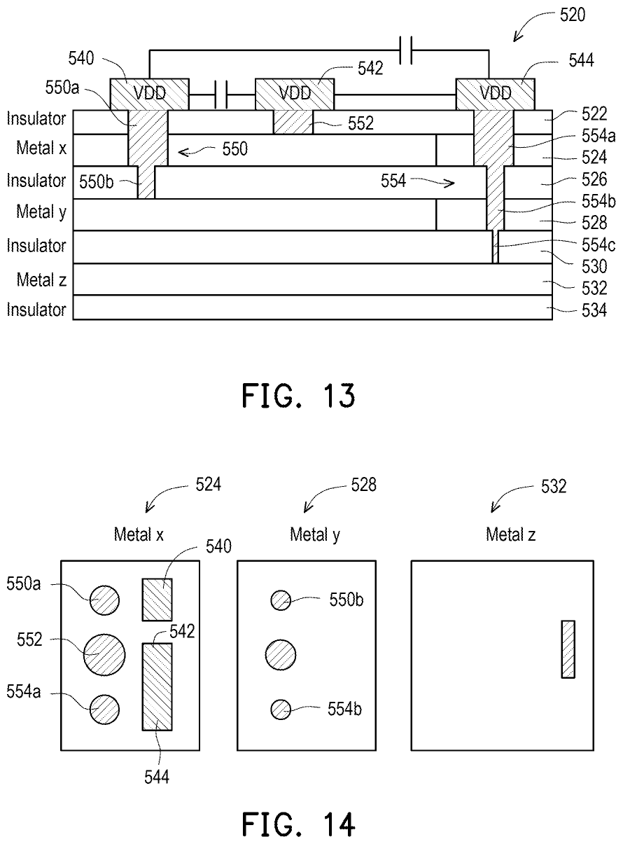

FIGS. 13 and 14 illustrate aspects of a multilayer metal-insulator-metal (MIM) capacitor structure 520. The illustrated example has three conductive metal layers, including a metal x layer 522, a metal y layer 528 and a metal z layer 532. A plurality of insulator layers 522, 526, 530 and 534 are positioned adjacent to and/or between the metal x layer 522, the metal y layer 528 and the metal z layer 532. Additionally, a VSS terminal 540 and two VDD terminals 542, 544 are situated over the insulator layer 522, with respective conductive vias 550, 552 and 554 extending through certain of the metal layers and/or insulator layers.

As shown in FIG. 13, the vias 550 and 554 have multiple segments of different sizes, or via diameters. The via 550 has a first segment 550a extending through the insulator layer 522 and the metal x layer 524, and a smaller via segment 550b extending through the insulator layer 526 to the metal y layer 528. The via 552 has only a main segment extending through the insulator layer 522 to the metal x layer 524. The via 554 has a first segment 554a extending through the insulator layer 522 and the metal x layer 524, a smaller via segment 554b extending through the insulator layer 526 and the metal y layer 528, and a still smaller via segment 554c extending through the insulator layer 530 to the metal z layer 532.

FIG. 14 illustrates top views of the metal x layer 524, the metal y layer 528 and the metal z layer 532, which contain the various via segments and metal contacts illustrated and discussed in conjunction with FIG. 13. The illustrated vias and corresponding via segments have round shapes with different sizes, i.e. different diameters in the illustrated examples. Further, the various rectangle shaped metal contacts have rectangles of various sizes.

The various sized shapes corresponding to the vias and contacts of the MIM capacitor 520 may be generated according to the of FIG. 3. Referring back to FIG. 3 together with FIGS. 13 and 14, a layout pattern including the MIM capacitor 520 is generated at operation 310. At the decision block 312, it is determined that the circle shape for the vias 550, 552, 554 is defined mathematically and stored in the shape generation database 432 of the memory 110 (see FIG. 4).

The method of FIG. 3 thus flows into the shape generation process 320. Parameters regarding the shape characteristics 324, such as the circle radius, are input to the shape generation process 326 along with additional information such as manufacturing grids, DRC, etc. the parameters received at operation 324 may be input by the user are retrieved from a memory such as the memory 110, or other storage or networked sites. A shape transformation file is generated at operation 326, which is then converted to a layout geometry file at operation 434. The process loops back to the decision block 312 until all the desired shapes have been defined.

As noted in conjunction with the discussion concerning FIG. 6, a circular via such as the via 472c may be generated using the general equation of a circle with the shape transform functions applied. For example, x,y coordinates for the circle shape corresponding to a corresponding via of the MIM capacitor 520 may be generated using parametric equations for a circle. Assuming the circle for the corresponding via is centered at the origin (0,0), parametric equations may be used to generate x, y coordinates of the circle.

$$\begin{matrix}x = r * cos ( θ ) \\ y = r * sin ( θ )\end{matrix}$$

The radius r defines the size of the circle shape for the various vias and via segments. The standard equation for a square (i.e. rectangle) may be similarly employed for generating the various rectangle shapes for the contacts 540, 542, 544. The generated shapes may be then transformed to a file suitable for geometry layout definitions.

Thus, rather than store manually drawn shape definitions in large GDS or LEF files or predetermined shape vertex lists, none of which are easily scaled, various disclosed embodiments store mathematical equations and transformation code to generate shapes for layout elements such as passive components (e.g. MIM capacitor 520) and connectors (e.g. vias 540, 542, 544).

In further examples, shapes are defined in three dimensions (3D). As with the 2D shapes, parametric equations may be generated and stored in the shape formula database 432 of the EDA system memory 110. The parametric equations are used in some examples to define x, y, z values and cycle through the parameters to generate points for shape definition. The parametric equations may be tailored to include different base shapes, where x and y parametric equations are generated. Parameters may be varied such as skewness scaling, x,y center position with respect to the z axis. Example basic parametric equations thus include

$$\begin{matrix}x = {S}_{x} ( x , y , z ) \cdot X ( y , z ) \\ y = {S}_{y} ( x , y , z ) \cdot Y ( x , z ) \\ z = {S}_{z} ( x , y , z ) \cdot Z ( x , y )\end{matrix}$$

Where Sₓ(x,y,z), S_{y}(x,y,z) and S_{z}(x,y,z) are shape transform functions and X(y,z), Y(x,z) and Z(x,y) are the base shape defining parametric functions.

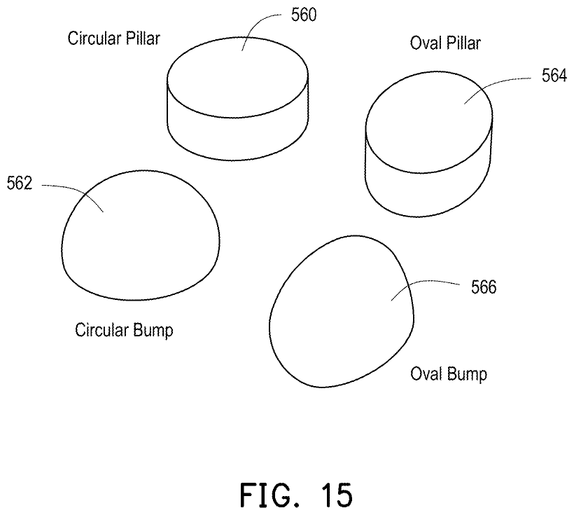

FIG. 15 illustrates examples of various 3D shapes that may be generated for layout elements, including a circular pillar 560, a circular bump 562, an oval pillar 564 and an oval bump 566. To generate the circular pillar 560 and oval pillar 564, a standard sphere equation may be used with a fixed z value in cartesian coordinates to generate x,y values with fixed z.

For the circular bump 562 and oval bump 566 3D shapes, the standard sphere equation in cartesian coordinates is used to generate x,y,z values. The standard equation for a circular sphere is

$${x}^{2} + {y}^{2} + {z}^{2} = {r}^{2}$$

Where z≥0 (i.e. upper portion of the sphere only). This may be restated as

$${( \frac{x}{r} )}^{2} + {( \frac{y}{r} )}^{2} + {( \frac{z}{r} )}^{2} = 1$$

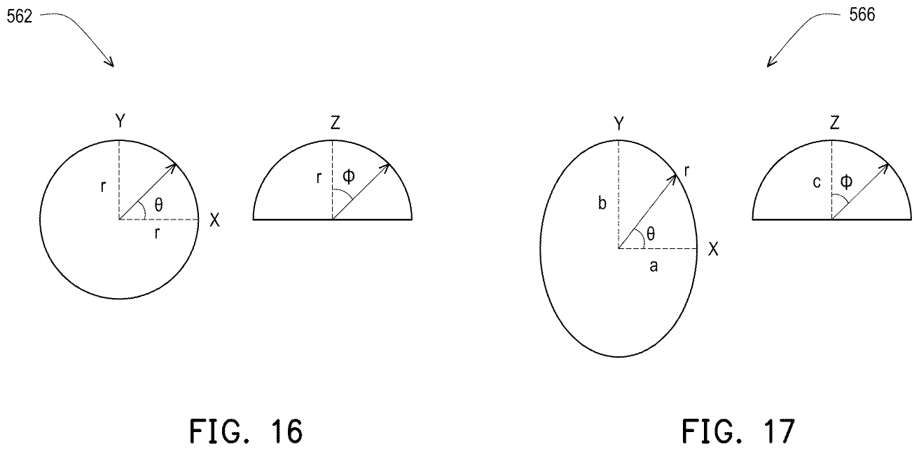

The x,y,z values may be determined by

$$\begin{matrix}x = r * sin ( ϕ ) * cos ( θ ) \\ y = r * sin ( ϕ ) * cos ( θ ) \\ z = r * cos ( ϕ ) ,\end{matrix}$$

Where 0°≤ϕ≤90°. This represents a sphere with its center at the origin and a radius of 1/r. FIG. 16 illustrates further aspects of the spherical bump 562, including aspects of the spherical bump 562 referred to in the equations shown above.

The sphere equation may be varied to define the oval bump 566 as shown below.

$${( \frac{x}{a} )}^{2} + {( \frac{y}{b} )}^{2} + {( \frac{z}{c} )}^{2} = 1$$

The x,y,z values may be determined by

$$\begin{matrix}x = a * sin ( ϕ ) * cos ( θ ) \\ y = b * sin ( ϕ ) * cos ( θ ) \\ z = c * cos ( ϕ ) ,\end{matrix}$$

Where 0°≤ϕ≤90°. FIG. 17 illustrates further aspects of the oval bump 562, including aspects of the spherical bump 566 referred to in the equations shown above.

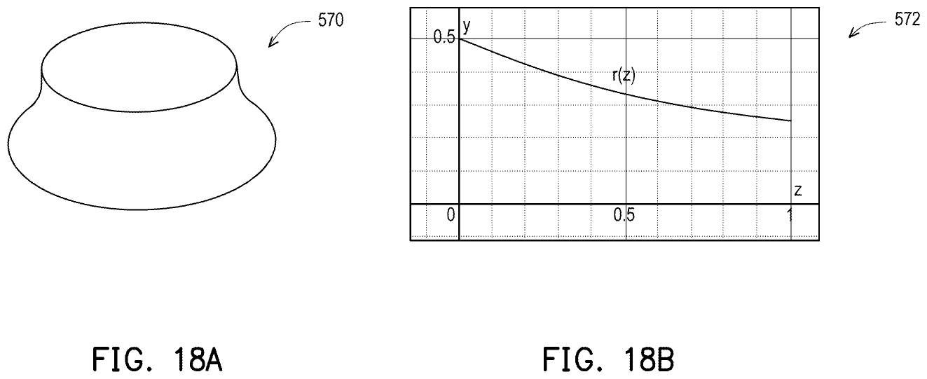

FIGS. 18-20 illustrate example shapes which may represent, for example, vias or other connectors, that have a circular base with a varying z-profile. In other words, the radius varies with the z axis according to a predetermined parametric profile.

$$\begin{matrix}x = r ( z ) \cdot cos θ \\ y = r ( z ) \cdot sin θ \\ z = \{ a \leq z \leq b \}\end{matrix}$$

FIG. 18A illustrates a circular shape 570 with a circular base and a radius r that decreases as z increases according to

$$r ( z ) = \frac{1}{2 ( z + 1 )} ; \{ 0 \leq z \leq 1 \}$$

FIG. 18B illustrates a corresponding plot 572 showing a radius profile where the radius values r decreases as z increases.

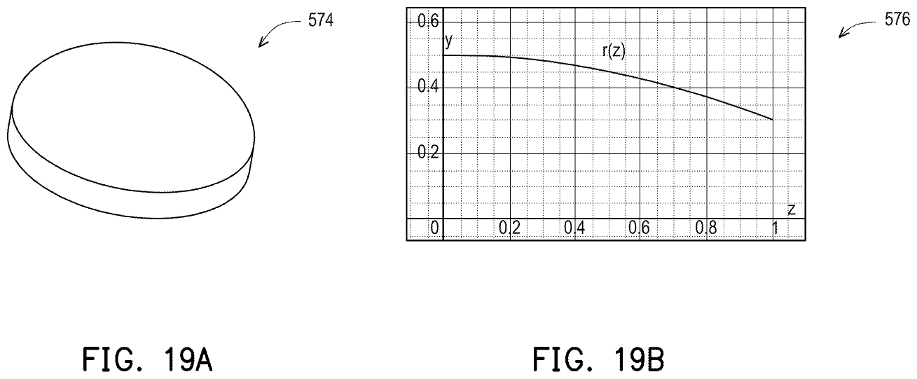

FIG. 19A illustrates another 3D shape 574 with a circular base and a radius r that decreases as z increases according to

$$r ( z ) = - \frac{{x}^{2}}{5} - 0.5 ; \{ 0 \leq z \leq 1 \}$$

FIG. 19B illustrates a corresponding plot 576 showing a radius profile where the radius values r decreases as z increases.

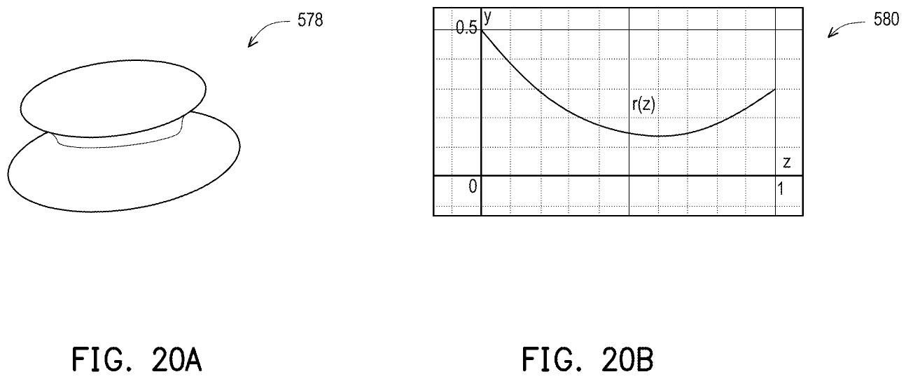

FIG. 20A illustrates a further 3D shape 578 with a circular base and a radius r that decreases then increases as z increases according to

$$r ( z ) = {( x - 0.6 )}^{2} + 0.14 ; \{ 0 \leq z \leq 1 \}$$

FIG. 20B illustrates a corresponding plot showing a radius profile where the radius values r decreases then increases as z increases.

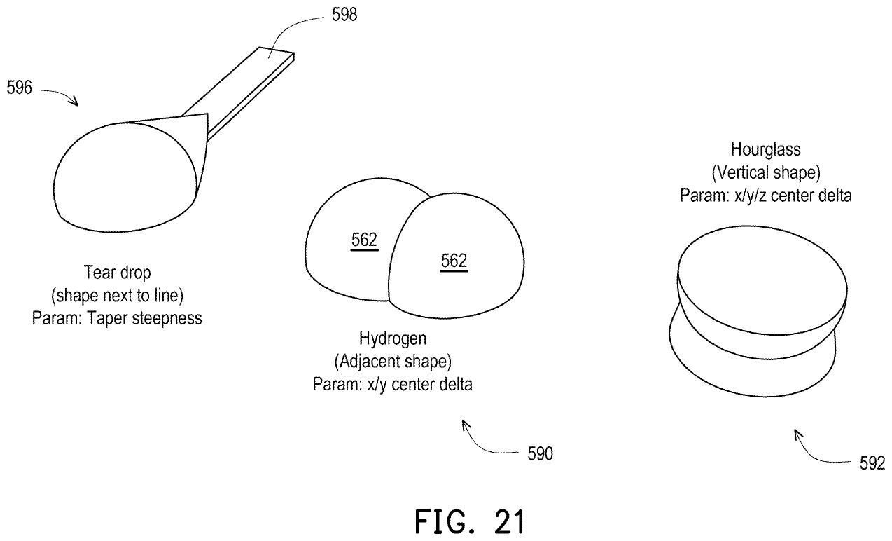

In some embodiments, shapes are generated by taking the union of existing shapes, for example two of the circular bump shapes 562 of FIG. 15 placed side by side to form a hydrogen-like profile 590 shown in FIG. 21. With the shape profile 590, parameters such as the x,y center information for the two circular bump shapes 562 re varied such that the x,y centers of the two shapes 562 overlap to form the hydrogen-like profile 590. FIG. 21 further illustrates an example of an hourglass shape profile 592, where the x,y center parameters are adjusted such that two bump shapes overlap in the x,y directions, and the z parameter is adjusted to get the desired vertical overlap.

The unions between two shapes could be further adjusted based on different input parameters to adjust for how the unions interact. For example x-y offset or z-direction offset may be varied to achieve the desired shape. FIG. 21 includes a 3D bump shape 594 which is situated next to a conductive line 596, where the input parameters cause the shape 594 to taper to the conductive line 596.

Thus, aspects of the disclosure provide methods and systems for describing and defining IC layout shapes. Such geometric shapes may describe circuitry or components of an electronic device, locations of the geometric shapes, and/or interconnections between the geometric shapes. In disclosed examples, mathematical equations and software code are used to perform shape vertex list generation, rather than relying on manually drawn shapes or pre-defined vertex lists. Thus, shape defining parameters are required only for the design of the element. This simplifies the process of varying shape defining parameters. With some implementations, shapes are created automatically and can be generated in parallel given sets of parameters. Creating elements with new shapes and/or sizes requires only changing the parameters in the shape-generating equations. Since only the shape defining equations need be stored, file sizes are reduced.

In accordance with some disclosed aspects, a method for creating a layout element includes receiving an integrated circuit (IC) layout pattern that includes a shape corresponding to a component of the layout pattern. A mathematical definition of the shape is retrieved from a shape database, and parameter inputs regarding characteristics of the shape are received. A vertex listing is created based on the mathematical definition of the shape and the parameter inputs, and a layout element that includes the shape is created based on the vertex listing.

In accordance with further disclosed aspects, a system such as an EDA system includes a processor, a shape database accessible by the processor that stores a plurality of mathematical definitions of a plurality of shapes, and a memory storage accessible by the processor and that stores instructions that when executed by the processor perform a method that includes receiving an integrated circuit (IC) layout pattern that includes a first shape corresponding to a first component of the layout pattern. A mathematical definition of the first shape is retrieved from the shape database, and parameter inputs regarding characteristics of the first shape are received. A vertex listing is generated based on the mathematical definition of the shape and the parameter inputs, and the vertex listing is converted to a layout geometry format. A layout element including the first shape is created.

In accordance with additional disclosed aspects, a method for creating a layout element includes determining a plurality of mathematical definitions of a plurality of shapes, storing the plurality of mathematical definitions in a shape database, and receiving an integrated circuit (IC) layout pattern by a processor. The IC layout includes a first shape corresponding to a component of the layout pattern. A mathematical definition of the first shape is retrieved from the shape database by the processor, and parameter inputs regarding characteristics of the first shape are received by the processor. A layout element including the first shape is created based on the mathematical definition and the parameter inputs.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method, comprising:
receiving an integrated circuit (IC) layout pattern that includes a shape corresponding to a component of the layout pattern;
retrieving a mathematical definition of the shape from a shape database;
receiving parameter inputs regarding characteristics of the shape;
generating a vertex listing based on the mathematical definition of the shape and the parameter inputs; and
creating a layout element including the shape based on the vertex listing.

2. The method of claim 1, further comprising converting the vertex listing to a graphics format.

3. The method of claim 2, wherein the graphics format includes a graphical data system file format.

4. The method of claim 1, wherein the mathematical definition includes a mathematical formula stored in the shapes database.

5. The method of claim 1, wherein the shape is a 2 dimensional (2D) shape.

6. The method of claim 1, wherein the shape is a 3 dimensional (3D) shape.

7. The method of claim 1, further comprising:
receiving a manufacturing grid corresponding to the layout pattern; and
wherein the vertex listing is generated further based on the manufacturing grid.

8. The method of claim 1, further comprising generating a photolithographic mask based on the layout element.

9. The method of claim 8, further comprising fabricating an IC based on the photolithographic mask.

10. The method of claim 1, further comprising:
if the shape database does not contain the mathematical definition of the shape, then creating the shape manually.

11. The method of claim 1, wherein the shape is a first shape, the mathematical definition is a first mathematical definition and the vertex listing is a first vertex listing, wherein the received IC layout pattern includes a second shape, and wherein the method further comprises:
retrieving a second mathematical definition of the second shape from the shape database;
receiving further parameter inputs regarding characteristics of the second shape;
generating a second vertex listing based on the second mathematical definition of the second shape and the further parameter inputs; and
wherein the layout element is based on the first and second vertex listings.

12. A system, comprising:
a processor;
a shape database accessible by the processor and storing a plurality of mathematical definitions of a plurality of shapes;
a memory storage accessible by the processor and storing instructions that when executed by the processor perform a method comprising:
receiving an integrated circuit (IC) layout pattern that includes a first shape corresponding to a first component of the layout pattern;
retrieving a mathematical definition of the first shape from the shape database;
receiving parameter inputs regarding characteristics of the first shape;
generating a vertex listing based on the mathematical definition of the shape and the parameter inputs;
converting the vertex listing to a layout geometry format; and
creating a layout element including the first shape.

13. The system of claim 12, wherein the IC layout pattern includes a passive component that includes the first shape.

14. The system of claim 12, wherein the first shape represents a connector.

15. The system of claim 12, wherein first shape represents a via.

16. The system of claim 12, wherein the plurality of mathematical definitions include mathematical formulas defining the plurality of shapes.

17. A method, comprising:
determining a plurality of mathematical definitions of a plurality of shapes;
storing the plurality of mathematical definitions in a shape database;
receiving an integrated circuit (IC) layout pattern by a processor, the IC layout including a first shape corresponding to a component of the layout pattern;
retrieving a mathematical definition of the first shape from the shape database by the processor;
receiving parameter inputs regarding characteristics of the first shape by the processor;
creating a layout element including the first shape based on the mathematical definition and the parameter inputs.

18. The method of claim 17, further comprising generating a vertex listing based on the mathematical definition and the parameter inputs.

19. The method of claim 17, wherein the shape is a 2 dimensional (2D) shape.

20. The method of claim 18, wherein the shape is a 3 dimensional (3D) shape.
